(19) United States
(12) Patent Application Publication
(10) Pub. No.: US 2009/0150976 A1
(43) Pub. Date: Jun. 11, 2009

(54) IP SERVICE CAPABILITY NEGOTIATION AND AUTHORIZATION METHOD AND SYSTEM

(76) Inventors: Nanjian QIAN, San Diego, CA (US); Yingzhe WU, San Marcos, CA (US)

Correspondence Address: MORRISON & FOERSTER LLP, 12531 HIGH BLUFF DRIVE, SUITE 100, SAN DIEGO, CA, 92130-2040, US

(21) Appl. No.: 12/327,762

(22) Filed: Dec. 3, 2008

Related U.S. Application Data
(60) Provisional application No. 60/992,063, filed on Dec. 3, 2007.

(51) Int. Cl. G06F 15/177; G06F 21/00

(52) U.S. Cl. 726/3; 709/220

(57) ABSTRACT

A method and system for negotiating and authorizing one or more IP services among a plurality of network entities in a wireless communication system is disclosed. In one embodiment, a system includes a transceiver module configured to receive one or more parameters of an access service network at a home connectivity service network of a mobile station. In addition, the one or more parameters of the access service network may be received at a visited connectivity service network, which transmits the one or more parameters of the access service network and one or more parameters of the visited connectivity service network to the home connectivity service network. This system further includes a home server unit authorizing one or more IP services, and transmitting network configuration information related to the authorized one or more IP services to the access service network.

### CROSS-REFERENCE TO RELATED APPLICATIONS

This application claims priority to U.S. Provisional Patent Application No. filed on Dec. 3, 2007, entitled “IP SERVICE CAPABILITY NEGOTIATION AND AUTHORIZATION SCHEME”, the content of which is incorporated by reference herein in its entirety.

### FIELD OF THE INVENTION

This invention relates generally to wireless communication networks, and more particularly, to a method and system for internet protocol (IP) service negotiation and authorization among various network entities.

### BACKGROUND OF THE INVENTION

Wireless network technologies, such as Worldwide Interoperability for Microwave Access (WiMAX), and the like, provide various IP services (e.g., simple IP, Proxy Mobile IP (PMIP) and Client Mobile IP (CMIP), including IP version 4 (IPv4) or IP version 6 (IPv6)) to users of mobile devices within networks involving multiple network entities. CMIP and PMIP are used by a mobile device to continue an IP session, even when a host attachment point changes due to movement of the mobile device. CMIP allows a mobile device to keep its transport connection opened and continue to be reachable while moving. PMIP was developed in part to eliminate signaling overhead, reduce software complexity/cost and require no network interface to change an IP address when the mobile device changes to a new router, for example. IPv4 refers to an early version of IP that is widely deployed, with the later version IPv6 providing updates and enhancements thereto.

With the increasing popularity of mobile devices, there exists a need to allow users to attach to various domains, depending on their current location. A user may require access to resources being provided by a visited network different than their home network. The need for service from a visited network requires, in many models, negotiation and authorization between the mobile device and the visited network.

Therefore, there is a need in the art to provide a method and system for IP service capability negotiation and authorization among different network entities. In addition, there is a need to leverage the network access authentication and authorization process to negotiate the appropriate IP service among various network entities using remote authentication protocols.

### SUMMARY OF THE INVENTION

The presently disclosed embodiments are directed to solving one or more of the problems presented in the prior art, described above, as well as providing additional features that will become readily apparent by reference to the following detailed description when taken in conjunction with the accompanying drawings.

One embodiment of the present disclosure is directed to a method for negotiating and authorizing one or more internet protocol (IP) services among a plurality of network entities in a wireless communication system. The method includes receiving one or more parameters of an access service network at a home connectivity service network of a mobile station; authorizing one or more IP services by the home connectivity service network, based on the one or more parameters; and transmitting network configuration information related to the authorized one or more IP services to the access service network.

Another embodiment of the present disclosure is directed to a system for negotiating and authorizing one or more IP services among a plurality of network entities in a wireless communication system. The system includes a transceiver module configured to receive one or more parameters of an access service network at a home connectivity service network of a mobile station. This system may further include a home server unit configured to authorize one or more IP services by the home connectivity service network, based on the one or more parameters, and to transmit, via the transceiver module, network configuration information related to the authorized one or more IP services to the access service network.

Yet another embodiment of the present invention is directed to a system for negotiating and authorizing one or more IP services among a plurality of network entities in a wireless communication system. The system includes means for receiving one or more parameters of an access service network at a home connectivity service network of a mobile station; and means for authorizing one or more IP services by the home connectivity service network, based on the one or more parameters; and means for transmitting network configuration information related to the authorized one or more IP services to the access service network.

Yet another embodiment of the present disclosure is directed to a wireless communication system configured to negotiate and authorize one or more IP services among a plurality of network entities. The system includes a mobile station, and an access service network configured to request authentication from the mobile station. The system may further include a transmitter unit coupled to the mobile station configured to transmit an Extensible Authentication Protocol (EAP) start message to the access service network in response to the request; an authenticator unit coupled to the access service network configured to transmit one or more parameters of the access service network to a home connectivity service network of a mobile station. The system may further include a home server unit coupled to the home connectivity service network configured to authorize one or more IP services, based on the one or more parameters, and to transmit network configuration information related to the authorized one or more IP services to the authenticator unit, wherein the home server unit is further configured to authenticate the mobile station; and a computer-readable memory coupled to the access service network configured to store the transmitted network configuration information, wherein the access service network is configured to determine at least one of the one or more authorized IP service to provide to the mobile station.

Yet another embodiment of the present disclosure is directed to a mobile station in a wireless communication system. The mobile station includes a transmitter unit configured to transmit a start message to an access service network in response to an authentication request. In response to the start message, the access service network is configured to transmit one or more parameters of the access service network to a home connectivity service network of the mobile station, and to determine at least one IP service to provide to the mobile station, based on authorization from the home connectivity service network.

According to certain embodiments, the authenticator unit is further configured to transmit one or more parameters of the access service network to an authenticator proxy unit in a visited connectivity service network, wherein the authenticator proxy unit is configured to transmit the one or more parameters of the access service network and one or more parameters of the visited connectivity service network from the visited connectivity service network to the home connectivity service network.

Thus, embodiments disclosed herein provide a method and system for IP service capability negotiation and authorization among different network entities, which allow users of mobile devices to attach to various visited networks, depending on their current location.

It is to be understood that both the foregoing general description and the following detailed description are exemplary and are merely intended to provide further explanation of the claimed subject matter.

### BRIEF DESCRIPTION OF THE DRAWINGS

The features, nature and advantages of the present disclosure will become more apparent from the detailed description set forth below when taken in conjunction with the drawings in which like reference characters identify correspondingly throughout and wherein:

FIG. 1 is an illustration of an exemplary architecture of a wireless communication system, according to one embodiment of the present invention.

FIG. 2 is an illustration of an exemplary mobile station in a wireless communication network, according to one embodiment of the present invention.

FIG. 3 is an illustration of an exemplary access service network, according to one embodiment of the present invention.

FIG. 4 is an illustration of an exemplary connectivity service network, according to one embodiment of the present invention.

FIG. 5 is a flow diagram illustrating an exemplary method for negotiating and authorizing one or more IP services among a plurality of network entities in a wireless communication system, according to one embodiment of the present invention.

FIG. 6 is a flow diagram illustrating an exemplary method for authenticating a mobile station in a wireless communication system, according to one embodiment of the present invention.

FIG. 7 is a flow diagram illustrating an exemplary method for transmitting one or more parameters of an access service network to a home connectivity service network of a mobile station in a wireless communication system, according to one embodiment of the present invention.

FIG. 8 is an exemplary RADIUS messages, including the access service network IP service capabilities, between an access service network and a home connectivity service network, according to one embodiment of the invention.

FIG. 9 is an exemplary RADIUS message, including visited connectivity service network IP service capability, according to one embodiment of the invention.

FIG. 10 is an exemplary RADIUS message, providing that the IP service capabilities include vHA-IP-MIP4, according to one embodiment of the invention.

FIG. 11 is an exemplary RADIUS message, providing that the IP service capabilities include vHA-IP-MIP6, according to one embodiment of the invention.

FIG. 12 is an exemplary RADIUS message, providing the IPv4 address of a vDHCPv4-Server, according to one embodiment of the invention.

FIG. 13 is an exemplary RADIUS message, providing the IPv6 address of a DHCP-Server, according to one embodiment of the invention.

FIG. 14 is an exemplary RADIUS message, providing the IPv4 address of the V-CSN LMA to use for PMIP6 anchoring, according to one embodiment of the invention.

FIG. 15 is an exemplary RADIUS message, providing the IPv4 address of the H-CSN LMA to use for PMIP6 anchoring, according to one embodiment of the invention.

FIG. 16 is an exemplary RADIUS message, providing the IPv6 address of the V-CSN vLMA to use for PMIP6 anchoring, according to one embodiment of the invention.

FIG. 17 is an exemplary RADIUS message, providing the IPv6 address of the H-CSN hLMA to use for PMIP6 anchoring, according to one embodiment of the invention.

FIG. 18 is an exemplary RADIUS message, providing the IPv4 address of the V-CSN vCR to use for Simple IP anchoring, according to one embodiment of the invention.

FIG. 19 is an exemplary RADIUS message, providing the IPv4 address of the H-CSN hCR to use for Simple IP anchoring, according to one embodiment of the invention.

FIG. 20 is an exemplary RADIUS message, providing the IPv6 address of the V-CSN vCR to use for Simple IP anchoring, according to one embodiment of the invention.

FIG. 21 is an exemplary RADIUS message, providing the IPv6 address of the H-CSN hCR to use for Simple IP anchoring, according to one embodiment of the invention.

### DETAILED DESCRIPTION OF EXEMPLARY EMBODIMENTS OF THE INVENTION

In the following description of exemplary embodiments, reference is made to the accompanying drawings which form a part hereof, and in which it is shown by way of illustration specific embodiments in which the invention may be practiced. It is to be understood that other embodiments may be utilized and structural changes may be made without departing from the scope of the present invention.

The word “exemplary” is used herein to mean “serving as an example or illustration.” Any aspect or design described herein as “exemplary” is not necessarily to be construed as preferred or advantageous over other aspects or designs.

Reference will now be made in detail to aspects of the subject technology, examples of which are illustrated in the accompanying drawings, wherein like reference numerals refer to like elements throughout.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

A WiMAX network, for example, can provide Simple IP, CMIP or PMIP services (IPv4 or IPv6) to an end user based on service provider business requirements, subscriber profiles, network architecture and network entity capability information. According to an embodiment of the present disclosure, in order to provide a successful user service session, several major network entities may be involved, including an access service network (ASN), a visited connectivity service network (V-CSN) and/or a home connectivity service network (H-CSN). Each network entity may contain multiple IP service related functional entities, which may represent specific IP service capabilities from this network entity. Whether the Simple IP service, PMIP or CMIP service is invoked by the network for a given user, may often depend on network IP service capability negotiation results among the ASN, V-CSN and H-CSN along with a home operator policy.

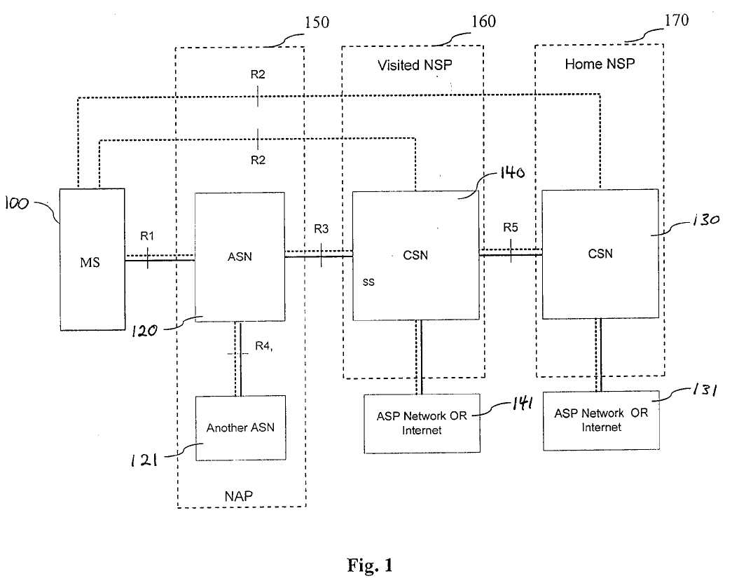

FIG. 1 is an illustration of an exemplary architecture of a wireless communication system, according to one embodiment of the present invention. The wireless communication network may be a WiMAX network that complies with the Institute of Electrical and Electronics Engineers (IEEE) 802.16 communication system protocol. However, the present invention is not limited to any particular network type, and various network technologies performing service capability negotiation may be implemented without departing from the scope of the present disclosure.

According to the embodiment depicted in FIG. 1, a wireless communication network includes mobile station 100, which may attempt to acquire IP services from ASN 120, within network access provider (NAP) 150, when mobile station 100 is in close proximity to ASN 120. ASN 120 provides, for example, a set of network functions that support radio access to mobile station 100, in accordance with one embodiment of the invention. ASN 120 negotiates and determines which IP services will be provided to mobile station 100, upon authorization by H-CSN 130. H-CSN 130 provides, for example, a set of network functions that support IP connectivity services to mobile station 100 which has IP connectivity capability, in accordance with one embodiment of the invention.

The wireless communication network of FIG. 1 includes a V-CSN 140, which may act as a proxy to H-CSN 130. That is, ASN 120 may transfer IP data to H-CSN 130 by “tunneling” through V-CSN 140, using connections R3 and R5. V-CSN 140 and H-CSN are within visited network service provider (NSP) 160 and home NSP 170, respectively. Both V-CSN 140 and H-CSN 130 are capable of providing access to respective application service provider (ASP) networks or the internet 141 and 131. Mobile station 100 may be wirelessly connected to V-CSN 140 and/or H-CSN 130 via connection R2 on the control plane. Mobile station 100 may be connected to ASN 120 by hardwire or wireless connection via connection R1. ASN 120 may be connected wirelessly or otherwise to one or more other ASNs 121, via connection R4. Of course, the above described architecture is merely an illustrative example and various other network entities, and combinations thereof, may be included without departing from the scope of the present disclosure.

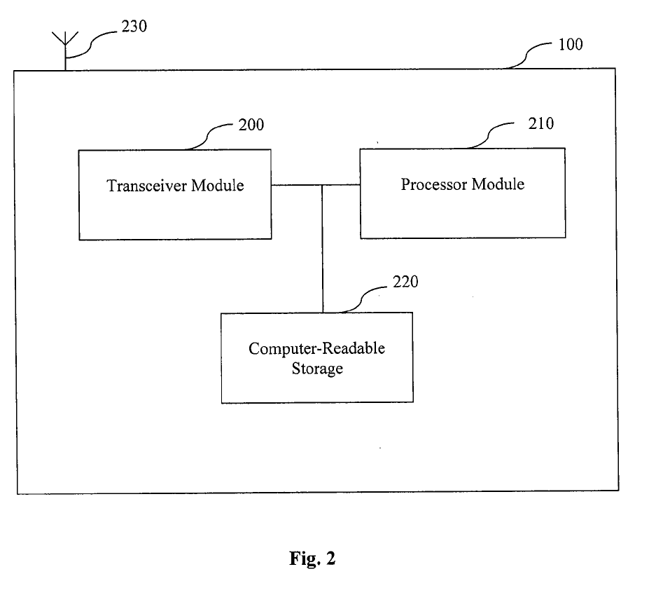

FIG. 2 is an illustration of an exemplary mobile station 100 in a wireless communication network, according to one embodiment of the present invention. In an exemplary embodiment, mobile station 100 may be used a user device such as a mobile phone. Alternately, mobile station 100 may be a personal digital assistant (PDA) such as a Blackberry device, MP3 player or other similar portable device. According to some embodiments, mobile station 100 may be a personal wireless computer such as a wireless notebook computer, a wireless palmtop computer, or other mobile computer devices.

The exemplary mobile station 100 depicted in FIG. 2 includes transceiver module 200 that may be configured to support alternate, or additional, wireless data communication protocols, including future variations of IEEE 802.16, such as 802.16e, 802.16m, and so on, using antenna 230. Transceiver module 200 generally enables bi-directional communication between mobile station 100 and various network entities. For example, transceiver module 200 may be configured to support internet or WiMAX traffic, as well as to provide an 802.3 Ethernet interface.

Mobile station 100 may further include processor module 210, which may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration. Processor module 210 may comprise processing logic that is configured to carry out the functions, techniques, and processing tasks associated with the operation of mobile station 100.

Furthermore, the steps of a method or algorithm described in connection with the embodiments disclosed herein may be embodied directly in hardware, in firmware, in a software module executed by processor module 210, or in any practical combination thereof. A software module may reside in computer-readable storage 220, which may be realized as RAM memory, flash memory, ROM memory, EPROM memory, EEPROM memory, registers, a hard disk, a removable disk, a CD-ROM, or any other form of storage medium known in the art. In this regard, computer-readable storage 220 may be coupled to processor module 210 such that processor module 210 can read information from, and write information to, computer-readable storage 220. As an example, processor module 210 and computer-readable storage 220 may reside in their respective ASICs. The computer-readable storage 220 may also be integrated into the processor module 210. In an embodiment, the computer-readable storage 220 may include a cache memory for storing temporary variables or other intermediate information during execution of instructions to be executed by processor module 210. Computer-readable storage 220 may also include non-volatile memory for storing instructions to be executed by processor module 210.

Computer-readable storage 220 may include a frame structure database (not shown) in accordance with an exemplary embodiment of the invention. Frame structure parameter databases may be configured to store, maintain, and provide data as needed to support the functionality of a wireless communication system in the manner described below. Moreover, a frame structure database may be a local database coupled to processor module 210, or may be a remote database, for example, a central network database, and the like. A frame structure database may be configured to maintain, without limitation, frame structure parameters as explained below. In this manner, a frame structure database may include a lookup table for purposes of storing frame structure parameters.

Of course, one of ordinary skill in the art would realize that the above-described mobile station 100 is merely one example, and various combinations of components, as well as other additional components, may be included without departing from the scope of the present disclosure.

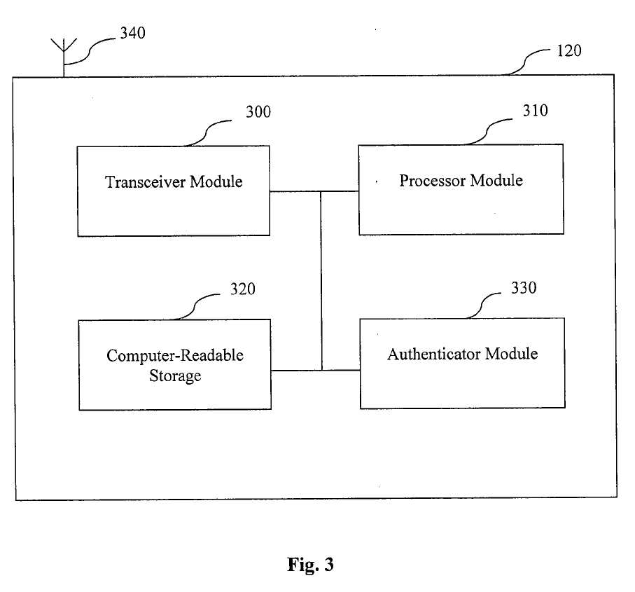

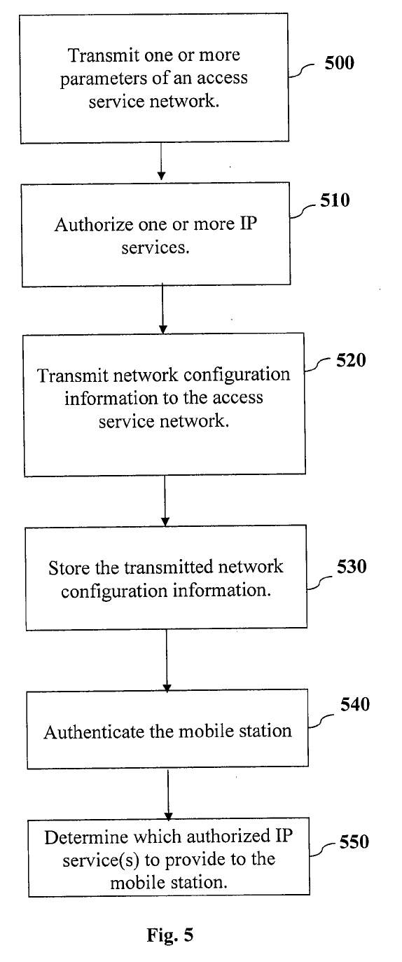

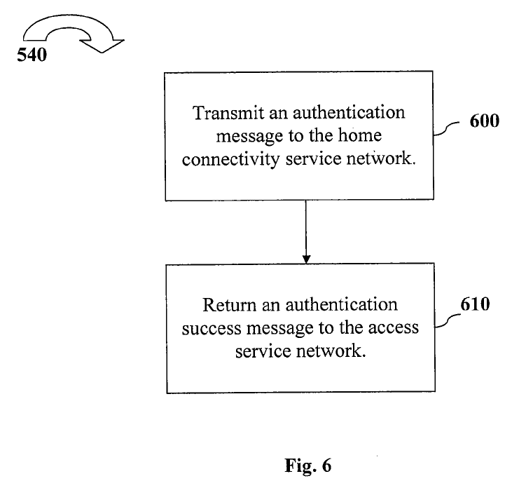

FIG. 3 is an illustration of an exemplary ASN 120, according to one embodiment of the present invention. Similar to mobile station 100, ASN 120 includes a transceiver module 300, coupled to antenna 340, as well as a processor module 310 and a computer-readable storage 320. Transceiver module 300, processor module 310 and computer-readable storage 320 may be configured similarly to transceiver module 200, processor module 210 and computer-readable storage 220 described above, with reference to FIG. 2. ASN 120 additionally includes an authenticator module 330, the functions of which will be described in further detail with reference to FIGS. 5 and 6 below.

Of course, one of ordinary skill in the art would realize that the above-described ASN 120 is merely one example, and various combinations of components, as well as other additional components, may be included without departing from the scope of the present disclosure.

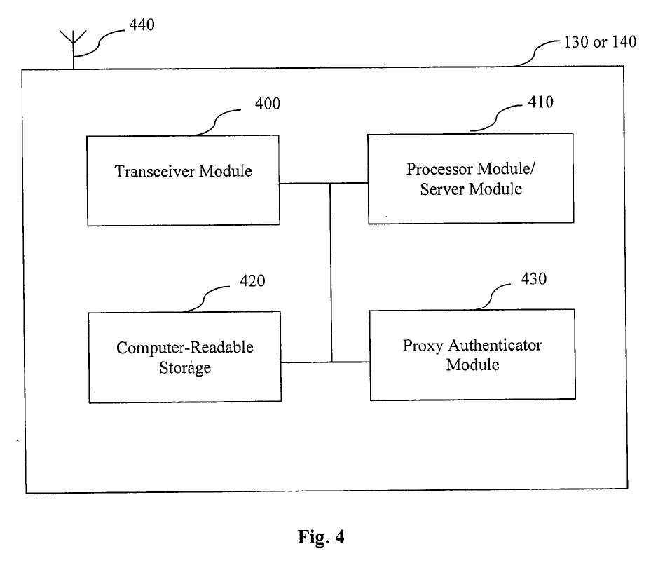

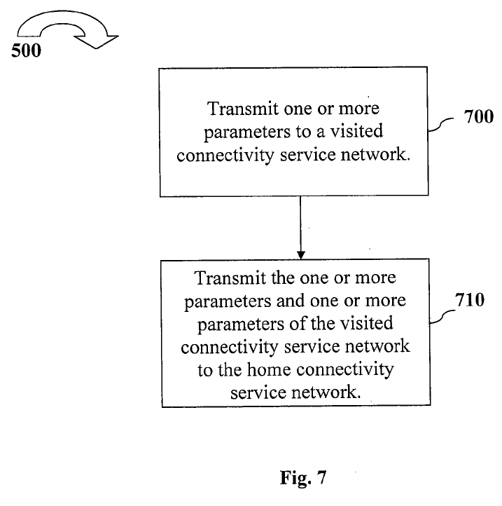

FIG. 4 is an illustration of an exemplary CSN (e.g., H-CSN 130 or V-CSN 140), according to one embodiment of the present invention. CSN 130 or 140 may include a transceiver module 400, communicatively coupled to antenna 440, and a computer-readable storage 420, with functionality similar to that described above with respect to transceiver module 200 and computer-readable storage 220 of FIG. 2. CSN 130 or 140 further includes a processor module/server module 410, which may be, for example, an Authentication, Authorization and Accounting (AAA) processor in an H-CSN 130. Functions thereof will be described in further detail with reference to FIG. 5 below. CSN 130 or 140 further includes a proxy authenticator module 430, in the case of a V-CSN 140, which is configured to transmit one or more parameters of the ASN 120 and one or more parameters of the V-CSN 140 from the V-CSN 140 to the H-CSN 130, as will be described in further detail with reference to FIG. 7 below. Processor module/server module 410 may be implemented, or realized, similarly to processor module 210 described above with reference to FIG. 2.

Of course, one of ordinary skill in the art would realize that the above-described CSN 130 or 140 is merely one example, and various combinations of components, as well as other additional components, may be included without departing from the scope of the present disclosure.

FIG. 5 is a flow diagram illustrating an exemplary method for negotiating and authorizing one or more IP services among a plurality of network entities in a wireless communication system, according to one embodiment of the present invention. When mobile station 100 seeks IP services from ASN 120, ASN 120 may request authentication. Mobile station 100 may respond to the access authentication request from ASN 120, by sending an EAP-Start message to ASN 120, as described in IEEE 802.16 protocol. At operation 500, authenticator module 330 of ASN 120 transmits, using transceiver module 300, one or more parameters of ASN 120 to processor module/server module 410 of H-CSN 130. The one or more parameters may include, for example, possible associated ASN 120 IP capabilities such as, Dynamic Host Configuration Protocol (DHCP) Relay, DHCP Proxy, foreign agent (FA), PMIP Client, mobile access gateway (MAG) with IPv4 transport, MAG with IPv6 transport, access router (AR) with IPv4 transport and AR with IPv6 transport. These parameters may be conveyed from ASN 120 to H-CSN through 130 using a Remote Authentication Dial In User Service (RADIUS) Access Request message, for example. RADIUS protocol is used throughout the present disclosure for exemplary purposes. One or ordinary skill in the art would realize that other similar protocols (e.g., Diameter protocol) maybe applied without departing from the scope of the present disclosure.

From operation 500, the process continues to operation 510, where processor module/server module 410 of H-CSN 130 authorizes one or more IP services to be provided to mobile station 100, based on the one or more parameters of ASN 120. That is, processor module/server module 410 of H-CSN 130 determines which IP services ASN 120 may provide based on the IP capabilities of ASN 120.

From operation 510, the process continues to operation 520, where processor module/server module 410 of H-CSN 130 transmits, via transceiver module 300, network configuration information related to the authorized one or more IP services to ASN 120. Processor module/server module 410 returns an EAP-Success message embedded in a RADIUS Access-Accept message to the authenticator module 330 of ASN 120. Network configuration information such as the home agent (HA) IP address, DHCP Server IP address, Core Router (CR) IP address, etc., may be included in the RADIUS Access-Accept message. Together with additional mobile station 100 parameters, ASN 120 IP service configuration attributes may also be included in the RADIUS Access-Accept message. These IP service configuration attributes will be used by ASN 120 as indication(s) of which IP service(s) has been authorized by processor module/server module 410 of H-CSN 130.

From operation 520, the process continues to operation 530, where the ASN 120 stores the network configuration information in computer-readable storage 320, and authenticator module 330 authenticates mobile station 100 at operation 540. According to certain embodiments, authenticator module 330 may also extract the EAP-Success message from RADIUS message and pass it onto to mobile station 100 to complete the access authentication operation. Once mobile station 100 is authenticated, the process continues to operation 550, where ASN 120 determines at least one of the one or more authorized IP services to provide to mobile station 100, depending on the stored IP service configuration parameters.

As exemplary determinations by ASN 120 regarding which IP services to provide to mobile station 100, if ASN 120 receives either visited Home Agent version 4 (vHAv4) or home Home Agent version 4 (hHAv4) attributes in the RADIUS Access Accept message, ASN 120 may store these HAv4 attributes locally and make them available to be used later for either CMIPv4 or PMIPv4 services to mobile station 100. If ASN 120 receives either vHAv6 or hHAv6 attributes in the RADIUS Access Accept message, ASN 120 may store these HAv6 attributes locally and make them available to be used later for CMIPv6 services to mobile station 100. If ASN 120 receives either visited local mobility agent (vLMA) or home local mobility agent (hLMA) attributes in the RADIUS Access Accept message, ASN 120 may store these attributes locally and make them available to be used later for PMIPv6 services to mobile station 100. If ASN 120 receives either visited Core Router (vCR) or home Core Router hCR) attributes in the RADIUS Access Accept message, ASN 120 may store these attributes locally and make them available to be used later for Simple IPv4 or Simple IPv6 services to mobile station 100. If ASN 120 receives DHCP Server attributes in the RADIUS Access Accept message, ASN 120 may store these attributes locally and make them available to be used in a DHCP signaling transaction later. It also may indicate that DHCP Relay functionality should be enabled for mobile station 100. If ASN 120 does not receive DHCP Server attributes in the RADIUS Access Accept message, it indicates that DHCP Proxy functionality should be enabled for mobile station 100. Of course, the present invention is not limited to these IP service determinations, and various IP services and combinations thereof may be provided to mobile station 100 without departing from the scope of the present disclosure.

FIG. 6 is a flow diagram illustrating an exemplary method for authenticating mobile station 100 in a wireless communication system, according to one embodiment of the present invention. At operation 600 authenticator module 330 of ASN 120 transmits, using transceiver module 300 as described above, an authentication message with the one or more parameters of ASN 120 to H-CSN 130 of mobile station 100.

From operation 600, the process continues to operation 610, where processor module/server module 410 of H-CSN 130 returns an authentication success message to ASN 120 if mobile station 100 is successfully authenticated by the H-CSN 140. As noted above, the authentication success message may be an EAP-success message embedded in the RADIUS Access Accept message, for example.

FIG. 7 is a flow diagram illustrating an exemplary method for transmitting one or more parameters of ASN 120 to H-CSN 130 of mobile station 100 in a wireless communication system, according to one embodiment of the present invention. When V-CSN 140 exists, transmissions between ASN 120 and H-CSN 130 may be relayed via V-CSN 140. At operation 700 authenticator module 330 of ASN 120 transmits, via transceiver module 300, the one or more parameters of ASN 120 to a proxy authenticator module 430 of V-CSN 140.

At operation 710, proxy authenticator module 430 transmits, via transceiver module 400, the one or more parameters of ASN 120 and one or more parameters of V-CSN 140 in the RADIUS Access Request message to processor module/server module 410 of H-CSN 130. The one or more parameters of V-CSN 140 may include, for example, possible IP Network Capabilities such as, DHCPv4 Server, DHCPv6 Server, HAv4, HAv6, LMA with IPv4 transport, LMA with IPv6 transport, CR with IPv4 transport and CR with IPv6 transport. Proxy authenticator module 430 may attach a vHA, vLMA, vCR, or vDHCP Server address to the RADIUS Access Request message. Similarly, the remaining procedural steps of FIG. 5 involving transmissions from ASN 120 to H-CSN 130 may be implemented using proxy authenticator module 430.

As exemplary determinations by ASN 120 regarding which IP services to provide to mobile station 100 when a V-CSN 140 exists, if ASN 120 receives vHAv4 or hHAv4 attributes, it indicates that H-CSN 130 has authorized to provide CMIPv4 and PMIPv4 service. If ASN 120 receives vHAv6 or hHAv6 attributes, it indicates that H-CSN 130 has authorized to provide CMIPv6 service. If ASN 120 receives vLMA or hLMA attributes, it indicates that H-CSN 130 has authorized to provide PMIPv6 service. If ASN 120 receives vCR or hCR attributes, it indicates that H-CSN 130 has authorized to provide Simple IPv4 or Simple IP service. If ASN 120 receives V-CSN 140 or H-CSN 130 DHCP Server attributes, it indicates that H-CSN 130 has authorized to use DHCP Relay functionality in ASN 120. If ASN 120 does not receive V-CSN 140 or H-CSN 130 DHCP Server attributes, it indicates that H-CSN 130 has authorized to use DHCP Proxy functionality in ASN 120. Of course, the present invention is not limited to these IP service determinations, and various IP services and combinations thereof may be provided to mobile station 100 without departing from the scope of the present disclosure.

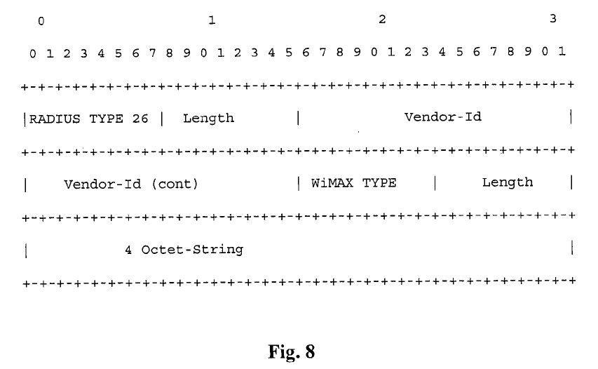

FIGS. 8-21, and the corresponding tables below, illustrate exemplary Type-Length-Value (TLV) definitions for RADIUS Vendor Specific Attributes, at least some of which have been adopted by “WiMAX Forum Network Architecture (Stage 3: Detailed Protocols and Procedures)”, Release 1, Version 1.3.0, Nov. 2, 2008. Of course, RADIUS protocol is merely used for exemplary purposes and other protocols may be employed without departing from the scope of the present invention.

For exemplary purposes, RADIUS Type 26 is depicted throughout FIGS. 8-21. However, other vendor specific attributes may be included, along with varying lengths and vendor-IDs. The vendor specific attributes (e.g., RADIUS Type 26, Length and Vendor-Id), as shown in FIGS. 8-21, may be represented by any common value(s), and are not described in the following tables. The following tables include specific attributes of WiMAX, such as the WiMAX Type (WType-ID), as well as corresponding lengths and bit mask values. 4 octet bit masks are illustrated for exemplary purposes; however, other lengths could be utilized within the scope of the present invention.

FIG. 8 illustrates an exemplary RADIUS TLV definition for Vendor Specific Attributes (e.g., WiMAX specific attributes) in a RADIUS message, including ASN 120 IP service capability, between ASN 120 and processor module/server module 410 of H-CSN 130, according to an embodiment of the invention. Of course other information can be included in a RADIUS message. A number or code, for example, may be identified with the WType-ID (see Table 1 below). For exemplary purposes, however, a “?” is shown throughout the following tables. One skilled in the art would realize that various numbers or codes could be used to represent the WType-ID, without departing from the scope of the present disclosure. Table 1 summarizes the exemplary information in the RADIUS message of FIG. 8:

TABLE 1

| | |
|---|---|
| WType-ID | ? ASN IP Service Capability |
| Description | This attribute can be included in a RADIUS |
| | Access-Request message to the RADIUS server and |
| | indicates ASN related IP Service Capabilities |
| Length | 6 + 3 + 4 |
| Continuation | C-bit = 0 |
| Value | 4 octet Bit Mask with the following values: |
| | 0x00000001 = DHCP Relay |
| | 0x00000002 = DHCP Proxy |
| | 0x00000004 = FA |
| | 0x00000008 = PMIP Client |
| | 0x00000010 = MAG with Ipv4 Transport |
| | 0x00000020 = MAG with Ipv6 Transport |
| | 0x00000040 = AR with Ipv4 Transport |
| | 0x00000080 = AR with Ipv6 Transport |
| | The rest bits are reserved |

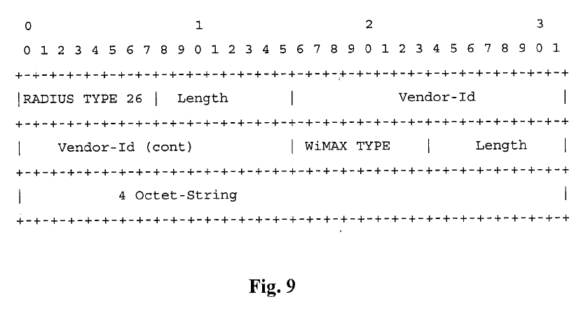

FIG. 9 illustrates an exemplary RADIUS TLV definition, including V-CSN 140 IP service capability according to an embodiment of the invention. As is shown in FIG. 9, the message may be substantially similar to the message of FIG. 8; however, the “WType-ID” value may differ. Of course other information can be included in a RADIUS message. Table 2 summarizes the exemplary information in the RADIUS message of FIG. 9:

TABLE 2

| | |
|---|---|
| WType-ID | ? V-CSN IP Service Capability |
| Description | This attribute can be included in a RADIUS |
| | Access-Request message to the RADIUS server and |
| | indicates V-CSN related IP Service Capabilities |
| Length | 6 + 3 + 4 |
| Continuation | C-bit = 0 |
| Value | 4 octet Bit Mask with the following values: |
| | 0x00000001 = DHCPv4 Server |
| | 0x00000002 = DHCPv6 Server |
| | 0x00000004 = HAv4 |
| | 0x00000008 = HAv6 |
| | 0x00000010 = LMA with Ipv4 Transport |
| | 0x00000020 = LMA with Ipv6 Transport |
| | 0x00000040 = CR with Ipv4 Transport |
| | 0x00000080 = CR with Ipv6 Transport |
| | The rest bits are reserved |

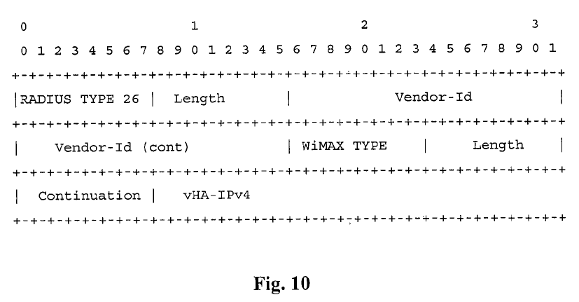

FIGS. 10-21, described below, provide exemplary RADIUS TLVs defining the value(s) of other parameters, such as the IP address of vHA-IPv4, the IP address of vLMA, etc. The TLVs are differentiated by the “WType-ID” value. However, these TLVs are merely exemplary, and could differ in various ways without departing from the scope of the present disclosure.

FIG. 10 illustrates an exemplary RADIUS TLV definition, providing that the ASN 120 and/or the V-CSN 140 IP service capabilities include vHA-IP-MIP4, according to an embodiment of the invention. Of course other information can be included in a RADIUS message. Table 3 summarizes the exemplary information in the RADIUS message of FIG. 10:

TABLE 3

| | |
|---|---|
| WType-ID | ? for VHA-IP-MIP4 |
| Description | The IPv4 address of the V-CSN HA for MIP4. |
| Length | 6 + 3 + 4 |
| Continuation | C-bit = 0 |
| Value | Octet string containing an IPv4 address |
| | (most significant bit first) |

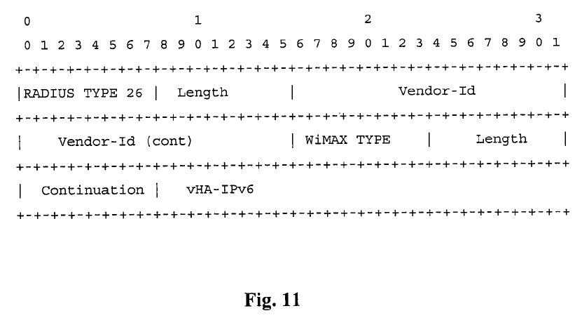

FIG. 11 illustrates an exemplary RADIUS TLV definition, providing that the ASN 120 and/or the V-CSN 140 IP service capabilities include vHA-IP-MIP6, according to an embodiment of the invention. Of course other information can be included in a RADIUS message. Table 4 summarizes the exemplary information in the RADIUS message of FIG. 11:

TABLE 4

| | |
|---|---|
| WType-ID | ? for VHA-IP-MIP6 |
| Description | The IPv6 address of the HA used for MIP6. |
| Length | 6 + 3 + 16 |
| Continuation | C-bit = 0 |
| Value | Octet string containing an IPv6 address |
| | (most significant bit first) |

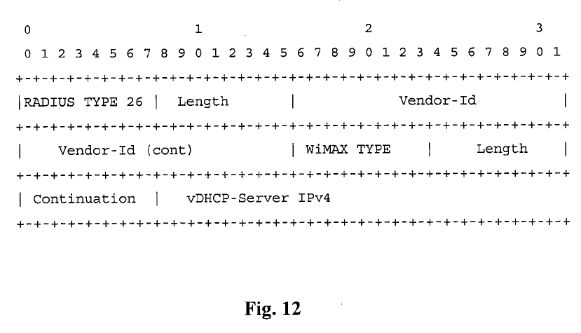

FIG. 12 illustrates an exemplary RADIUS TLV definition, providing the address of a vDHCPv4-Server, according to an embodiment of the invention. Of course other information can be included in a RADIUS message. Table 5 summarizes the exemplary information in the RADIUS message of FIG. 12:

TABLE 5

| | |
|---|---|
| WType-ID | ? for vDHCPv4-Server |
| Description | The IPv4 address of the V-CSN DHCP-Server |
| | to use for IPv4 address allocation |
| Length | 6 + 3 + 4 |
| Continuation | C-bit = 0 |
| Value | Octet string containing an IPv4 address |
| | (most significant bit first). |

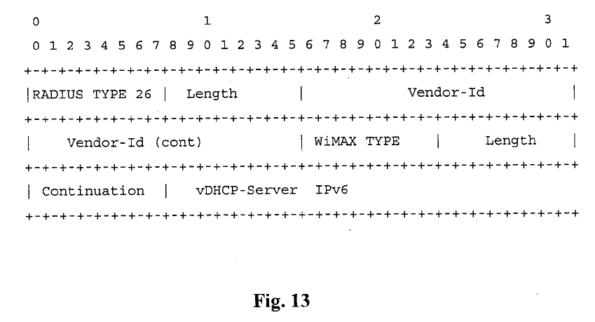

FIG. 13 illustrates an exemplary RADIUS TLV definition, providing the IPv6 address of a DHCP-Server, according to an embodiment of the invention. Of course other information can be included in a RADIUS message. Table 6 summarizes the exemplary information in the RADIUS message of FIG. 13:

TABLE 6

| | |
|---|---|
| WType-ID | ? for vDHCPv6-Server |
| Description | The IPv6 address of the HA used for MIP6. |
| Length | 6 + 3 + 16 |
| Continuation | C-bit = 0 |
| Value | Octet string containing an IPv6 address |
| | (most significant bit first) |

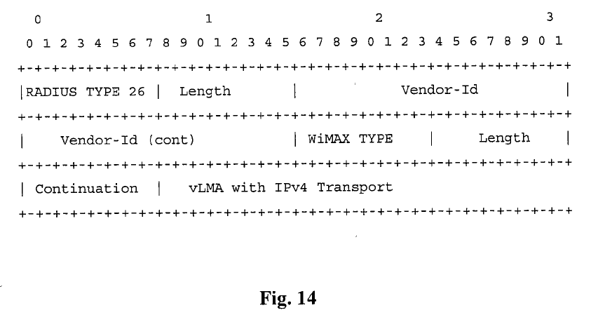

FIG. 14 illustrates an exemplary RADIUS TLV definition, providing the address of the V-CSN LMA to use for PMIP6 anchoring, according to an embodiment of the invention. Of course other information can be included in a RADIUS message. Table 7 summarizes the exemplary information in the RADIUS message of FIG. 14:

TABLE 7

| | |
|---|---|
| WType-ID | ? for vLMA with IPv4 Transport |
| Description | The IPv4 address of the V-CSN LMA to use |
| | for IPv4 address allocation |
| Length | 6 + 3 + 4 |
| Continuation | C-bit = 0 |
| Value | Octet string containing an IPv4 address |
| | (most significant bit first). |

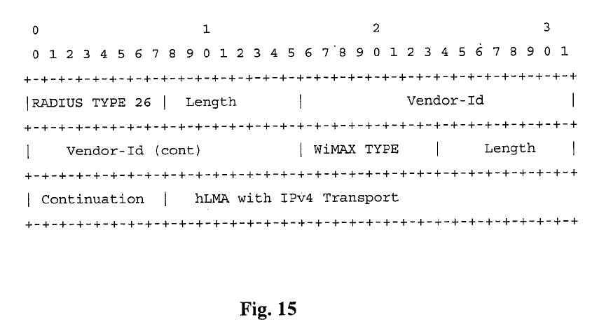

FIG. 15 illustrates an exemplary RADIUS TLV definition, providing the IPv4 address of the H-CSN LMA to use for PMIP6 anchoring, according to an embodiment of the invention. Of course other information can be included in a RADIUS message. Table 8 summarizes the exemplary information in the RADIUS message of FIG. 15:

TABLE 8

| | |
|---|---|
| WType-ID | ? for hLMA with IPv4 Transport |
| Description | The IPv4 address of the H-CSN LMA to use |
| | for IPv4 address allocation |
| Length | 6 + 3 + 4 |
| Continuation | C-bit = 0 |
| Value | Octet string containing an IPv4 address |
| | (most significant bit first). |

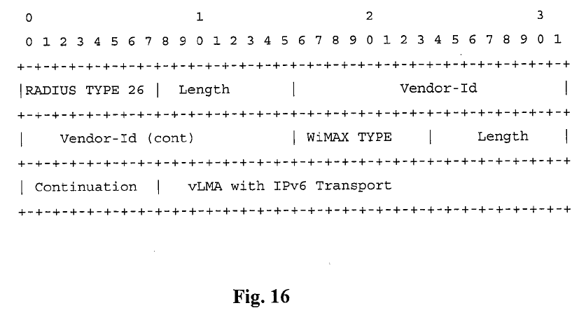

FIG. 16 illustrates an exemplary RADIUS TLV definition, providing the IPv6 address of the V-CSN LMA to use for PMIP6 anchoring, according to an embodiment of the invention. Of course other information can be included in a RADIUS message. Table 9 summarizes the exemplary information in the RADIUS message of FIG. 16:

TABLE 9

| | |
|---|---|
| WType-ID | ? for vLMA with IPv6 Transport |
| Description | The IPv4 address of the V-CSN LMA to use |
| | for IPv6 address allocation |
| Length | 6 + 3 + 16 |
| Continuation | C-bit = 0 |
| Value | Octet string containing an IPv6 address |
| | (most significant bit first). |

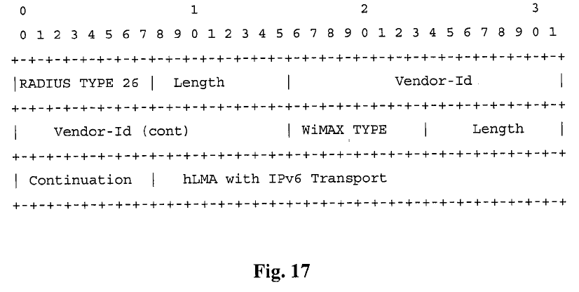

FIG. 17 illustrates an exemplary RADIUS TLV definition, providing the IPv6 address of the H-CSN hLMA to use for PMIP6 anchoring, according to an embodiment of the invention. Of course other information can be included in a RADIUS message. Table 10 summarizes the exemplary information in the RADIUS message of FIG. 17:

TABLE 10

| | |
|---|---|
| WType-ID | ? for hLMA with IPv6 Transport |
| Description | The IPv4 address of the H-CSN LMA to use |
| | for IPv6 address allocation |
| Length | 6 + 3 + 16 |
| Continuation | C-bit = 0 |
| Value | Octet string containing an IPv6 address |
| | (most significant bit first). |

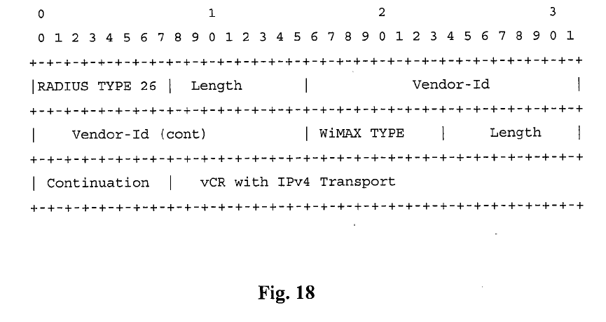

FIG. 18 illustrates an exemplary RADIUS TLV definition, providing the address of the V-CSN vCR to use for Simple IP anchoring, according to an embodiment of the invention. Of course other information can be included in a RADIUS message. Table 11 summarizes the exemplary information in the RADIUS message of FIG. 18:

TABLE 11

| | |
|---|---|
| WType-ID | ? for vCR with IPv4 Transport |
| Description | The IPv4 address of the V-CSN CR to use |
| | for IPv4 address allocation |
| Length | 6 + 3 + 4 |
| Continuation | C-bit = 0 |
| Value | Octet string containing an IPv4 address |
| | (most significant bit first). |

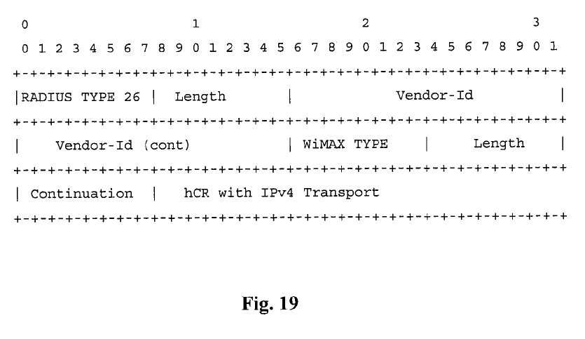

FIG. 19 illustrates an exemplary RADIUS TLV definition, providing the IPv4 address of the H-CSN hCR to use for Simple IP anchoring, according to an embodiment of the invention. Of course other information can be included in a RADIUS message. Table 12 summarizes the exemplary information in the RADIUS message of FIG. 19:

TABLE 12

| | |
|---|---|
| WType-ID | ? for hCR with IPv4 Transport |
| Description | The IPv4 address of the H-CSN CR to use |
| | for IPv4 address allocation |
| Length | 6 + 3 + 4 |
| Continuation | C-bit = 0 |
| Value | Octet string containing an IPv4 address |
| | (most significant bit first). |

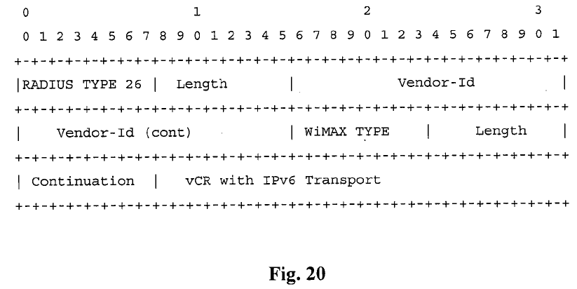

FIG. 20 illustrates an exemplary RADIUS TLV definition, providing the IPv6 address of the V-CSN vCR to use for Simple IP anchoring, according to an embodiment of the invention. Of course other information can be included in a RADIUS message. Table 13 summarizes the exemplary information in the RADIUS message of FIG. 20:

TABLE 13

| | |
|---|---|
| WType-ID | ? for vCR with IPv6 Transport |
| Description | The IPv4 address of the V-CSN CR to use |
| | for IPv6 address allocation |
| Length | 6 + 3 + 16 |
| Continuation | C-bit = 0 |
| Value | Octet string containing an IPv6 address |
| | (most significant bit first). |

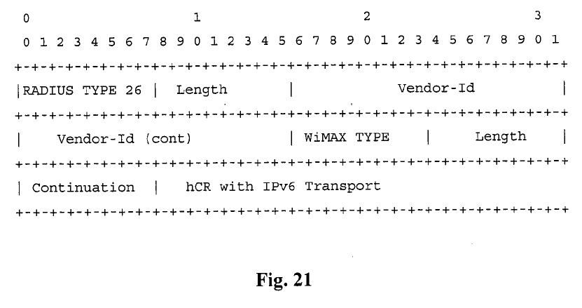

FIG. 21 illustrates an exemplary RADIUS TLV definition, providing the IPv6 address of the H-CSN hCR to use for Simple IP anchoring, according to an embodiment of the invention. Of course other information can be included in a RADIUS message. Table 14 summarizes the exemplary information in the RADIUS message of FIG. 21:

TABLE 14

| | |
|---|---|
| WType-ID | ? for hCR with IPv6 Transport |
| Description | The IPv4 address of the H-CSN CR to use |
| | for IPv6 address allocation |
| Length | 6 + 3 + 16 |
| Continuation | C-bit = 0 |
| Value | Octet string containing an IPv6 address |
| | (most significant bit first). |

Embodiments of the present invention are directed to transmitting one or more parameters of an access service network to a home connectivity service network of a mobile station; authorizing one or more IP services by the home connectivity service network, based on the one or more parameters; and transmitting network configuration information related to the authorized one or more IP services to the access service network. Further, embodiments described herein are capable of transmitting one or more parameters of the access service network to a visited connectivity service network; and transmitting the one or more parameters of the access service network and one or more parameters of the visited connectivity service network from the visited connectivity service network to the home connectivity service network

Thus, the methods and systems described herein provide for IP service capability negotiation and authorization among different network entities. In addition, embodiments of the present invention are capable of leveraging the network access authentication and authorization process to negotiate the appropriate IP service among various network entities using remote authentication protocols.

Although the present invention has been fully described in connection with embodiments thereof with reference to the accompanying drawings, it is to be noted that various changes and modifications will become apparent to those skilled in the art. Such changes and modifications are to be understood as being included within the scope of the present invention as defined by the appended claims.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method for negotiating and authorizing one or more internet protocol (IP) services among a plurality of network entities in a wireless communication system, comprising:
receiving one or more parameters of an access service network at a home connectivity service network of a mobile station;
authorizing one or more IP services by the home connectivity service network, based on the one or more parameters; and
transmitting network configuration information related to the authorized one or more IP services to the access service network.

2. The method of claim 1, further comprising:
storing the transmitted network configuration information at the access service network.

3. The method of claim 1, further comprising:
determining, at the access service network, at least one of the one or more authorized IP service to provide to the mobile station.

4. The method of claim 1, further comprising:
authenticating the mobile station.

5. The method of claim 4, wherein the authenticating comprises:
transmitting an authentication message with the one or more parameters of the access service network to the home connectivity service network of the mobile station; and
returning an authentication success message to the access service network if the mobile station is successfully authenticated by the home connectivity service network.

6. The method of claim 1, wherein the receiving the one or more parameters of the access service network comprises:
receiving one or more parameters of the access service network at a visited connectivity service network; and
receiving the one or more parameters of the access service network and one or more parameters of the visited connectivity service network from the visited connectivity service network by the home connectivity service network.

7. The method of claim 1, wherein the at least one of the plurality of network entities is part of a Wireless Interoperability for Microwave Access (WiMAX) network.

8. The method of claim 1, wherein the one or more IP services include at least one of Simple IP, Proxy Mobile IP (PMIP) and Common Management IP (CMIP).

9. The method of claim 1, wherein the receiving the one or more parameters of the access service network and the transmitting the network configuration information are implemented using Remote Authentication Dial In User Service (RADIUS) protocol.

10. The method of claim 1, wherein the receiving the one or more parameters of the access service network and the transmitting the network configuration information are implemented using a diameter protocol.

11. A system for negotiating and authorizing one or more internet protocol (IP) services among a plurality of network entities in a wireless communication system, comprising:
a transceiver module configured to receive one or more parameters of an access service network at a home connectivity service network of a mobile station; and
a home server unit configured to authorize one or more IP services by the home connectivity service network, based on the one or more parameters, and to transmit, via the transceiver module, network configuration information related to the authorized one or more IP services to the access service network.

12. The system of claim 11, further comprising:
a storage unit configured to store the transmitted network configuration information at the access service network.

13. The system of claim 11, wherein the access service network is configured to determine at least one of the one or more authorized IP service to provide to the mobile station.

14. The system of claim 11, the home server unit further configured to authenticate the mobile station.

15. The system of claim 14, wherein
an authentication message is received with the one or more parameters of the access service network at the home connectivity service network of the mobile station, and
the home server unit is further configured to return an authentication success message to the access service network if the mobile station is successfully authenticated by the home connectivity service network.

16. The system of claim 11, wherein:
the one or more parameters of the access service network are received at an authenticator proxy unit in a visited connectivity service network, wherein the authenticator proxy unit is configured to transmit the one or more parameters of the access service network and one or more parameters of the visited connectivity service network from the visited connectivity service network to the home connectivity service network.

17. The system of claim 11, wherein the at least one of the plurality of network entities is part of a Wireless Interoperability for Microwave Access (WiMAX) network.

18. The system of claim 11, wherein the one or more IP services include at least one of Simple IP, Proxy Mobile IP (PMIP) and Common Management IP (CMIP).

19. The system of claim 11, wherein the one or more parameters of the access service network and the network configuration information are transmitted using Remote Authentication Dial In User Service (RADIUS) protocol.

20. The system of claim 11, wherein the one or more parameters of the access service network and the network configuration information are transmitted using diameter protocol.

21. A system for negotiating and authorizing one or more internet protocol (IP) services among a plurality of network entities in a wireless communication system, comprising:
means for receiving one or more parameters of an access service network at a home connectivity service network of a mobile station;
means for authorizing one or more IP services by the home connectivity service network, based on the one or more parameters; and
means for transmitting network configuration information related to the authorized one or more IP services to the access service network.

22. The system of claim 21, further comprising:
means for storing the transmitted network configuration information at the access service network.

23. The system of claim 21, further comprising:
means for determining, at the access service network, at least one of the one or more authorized IP service to provide to the mobile station.

24. The system of claim 21, further comprising:
means for authenticating the mobile station.

25. The system of claim 24, wherein the means for authenticating comprises:
means for transmitting an authentication message with the one or more parameters of the access service network to the home connectivity service network of the mobile station; and
means for returning an authentication success message to the access service network if the mobile station is successfully authenticated by the home connectivity service network.

26. The system of claim 21, wherein the means for receiving the one or more parameters of the access service network comprises:
means for receiving one or more parameters of the access service network at a visited connectivity service network; and
means for receiving the one or more parameters of the access service network and one or more parameters of the visited connectivity service network at the home connectivity service network.

27. The system of claim 21, wherein the at least one of the plurality of network entities is part of a Wireless Interoperability for Microwave Access (WiMAX) network.

28. The system of claim 21, wherein the one or more IP services include at least one of Simple IP, Proxy Mobile IP (PMIP) and Common Management IP (CMIP).

29. The system of claim 21, wherein the means for transmitting the one or more parameters of the access service network and the means for transmitting the network configuration information are implemented using a Remote Authentication Dial In User Service (RADIUS) protocol.

30. The system of claim 21, wherein the means for transmitting the one or more parameters of the access service network and the means for transmitting the network configuration information are implemented using a diameter protocol.

31. A wireless communication system configured to negotiate and authorize one or more internet protocol (IP) services among a plurality of network entities, comprising:
a mobile station;
an access service network configured to request authentication from the mobile station;
a transmitter unit coupled to the mobile station configured to transmit an Extensible Authentication Protocol (EAP) start message to the access service network in response to the request;
an authenticator unit coupled to the access service network configured to transmit one or more parameters of the access service network to a home connectivity service network of a mobile station;
a home server unit coupled to the home connectivity service network configured to authorize one or more IP services, based on the one or more parameters, and to transmit network configuration information related to the authorized one or more IP services to the authenticator unit, wherein the home server unit is further configured to authenticate the mobile station;
a computer-readable memory coupled to the access service network configured to store the transmitted network configuration information,
wherein the access service network is configured to determine at least one of the one or more authorized IP service to provide to the mobile station.

32. The system of claim 31, wherein the authenticator unit is further configured to:
transmit one or more parameters of the access service network to an authenticator proxy unit in a visited connectivity service network, wherein the authenticator proxy unit is configured to transmit the one or more parameters of the access service network and one or more parameters of the visited connectivity service network from the visited connectivity service network to the home connectivity service network.

33. A mobile station in a wireless communication system, comprising:
a transmitter unit configured to transmit a start message to an access service network in response to an authentication request, wherein
in response to the start message, the access service network is configured to transmit one or more parameters of the access service network to a home connectivity service network of the mobile station, and to determine at least one IP service to provide to the mobile station, based on authorization from the home connectivity service network.
